(19) United States
(12) Patent Application Publication
(10) Pub. No.: US 2013/0114888 A1
(43) Pub. Date: May 9, 2013

(54) IMAGE PROCESSING APPARATUS, COMPUTER PROGRAM PRODUCT, AND IMAGE PROCESSING METHOD

(71) Applicants: Kanako SAITO, Kanagawa (JP); Toshimitsu KANEKO, Kanagawa (JP); Susumu KUBOTA, Tokyo (JP); Yusuke MORIUCHI, Kanagawa (JP)

(72) Inventors: Kanako SAITO, Kanagawa (JP); Toshimitsu KANEKO, Kanagawa (JP); Susumu KUBOTA, Tokyo (JP); Yusuke MORIUCHI, Kanagawa (JP)

(21) Appl. No.: 13/671,171

(22) Filed: Nov. 7, 2012

(30) Foreign Application Priority Data
Nov. 8, 2011 (JP) 2011-244668
May 22, 2012 (JP) 2012-117025

(51) Int. Cl. G06K 9/62

(52) U.S. Cl. 382/159

(57) ABSTRACT

According to an embodiment, an image processing apparatus includes a feature data calculator, a generating unit, and an adding unit. The feature data calculator calculates feature data representing changes in pixel values within a first range of an input image. The generating unit obtains a weight of a predetermined image pattern on the basis of a probability distribution and the feature data. The weight represents a pattern of changes in the pixel values. The probability distribution represents a distribution of relative values of feature data of a learning image containing a high-frequency component with respect to feature data of a learning image. The generating unit weights the predetermined image pattern with the weight so as to generate a high-frequency component with respect to the input image. The adding unit adds the high-frequency component to the input image.

### CROSS-REFERENCE TO RELATED APPLICATION(S)

This application is based upon and claims the benefit of priority from Japanese Patent Application No. 2011-244668, filed on Nov. 8, 2011 and Japanese Patent Application No. 2012-117025, filed on May 22, 2012; the entire contents of which are incorporated herein by reference.

### FIELD

Embodiments described herein relate generally to an image processing apparatus, a computer program product, and an image processing method.

### BACKGROUND

Typically, in a camera or a television receiver, a variety of image processing is performed with the aim of enhancing the image resolution or the image quality. As one type of image processing, a technique is known for reinforcing the edge portions of images. By implementing that technique, it becomes possible to generate sharper images.

However, in the conventional technique, it is a difficult task to generate images having naturalness. More particularly, in the conventional technique, since the edge portion of an image is reinforced, it becomes difficult to generate an image having naturalness in entirety.

### BRIEF DESCRIPTION OF THE DRAWINGS

FIG. 1 is a block diagram of a configuration example of an image processing apparatus according to a first embodiment;

FIG. 2 is a diagram for explaining a distribution calculating unit according to the first embodiment;

FIG. 3 is a diagram for explaining the probability distribution according to the first embodiment;

FIG. 4 is a flowchart for explaining a sequence of operations followed during the image processing according to the first embodiment;

FIG. 5 is a block diagram of a configuration example of an image processing apparatus according to a second embodiment;

FIG. 6 is a flowchart for explaining a sequence of operations followed during the image processing according to the second embodiment;

FIG. 7 is a block diagram of a configuration example of an image processing apparatus according to a third embodiment;

FIG. 8 is a flowchart for explaining a sequence of operations followed during the image processing according to the third embodiment;

FIG. 9 is a block diagram of a configuration example of an image processing apparatus according to a fourth embodiment;

FIG. 10 is a diagram for explaining a distribution calculating unit according to the fourth embodiment;

FIG. 11 is a flowchart for explaining a sequence of operations followed during the image processing according to the fourth embodiment;

FIG. 12 is a block diagram of a configuration example of an image processing apparatus according to a fifth embodiment;

FIG. 13A is a diagram for explaining histograms in gradient directions according to the fifth embodiment;

FIG. 13B is a histogram in the gradient directions according to the fifth embodiment;

FIG. 14 is a flowchart for explaining a sequence of operations followed during the image processing according to the fifth embodiment; and

FIG. 15 is a diagram illustrating an exemplary image processing apparatus according to each embodiment.

### DETAILED DESCRIPTION

According to an embodiment, an image processing apparatus includes a feature data calculator, a generating unit, and an adding unit. The feature data calculator calculates feature data representing changes in pixel values within a first range of an input image. The generating unit obtains a weight of a predetermined image pattern on the basis of a probability distribution and the feature data. The weight represents a pattern of changes in the pixel values. The probability distribution represents a distribution of relative values of feature data of a learning image containing a high-frequency component with respect to feature data of a learning image. The generating unit weights the predetermined image pattern with the weight so as to generate a high-frequency component with respect to the input image. The adding unit adds the high-frequency component to the input image.

Various embodiments will be described hereinafter with reference to the accompanying drawings.

### First Embodiment

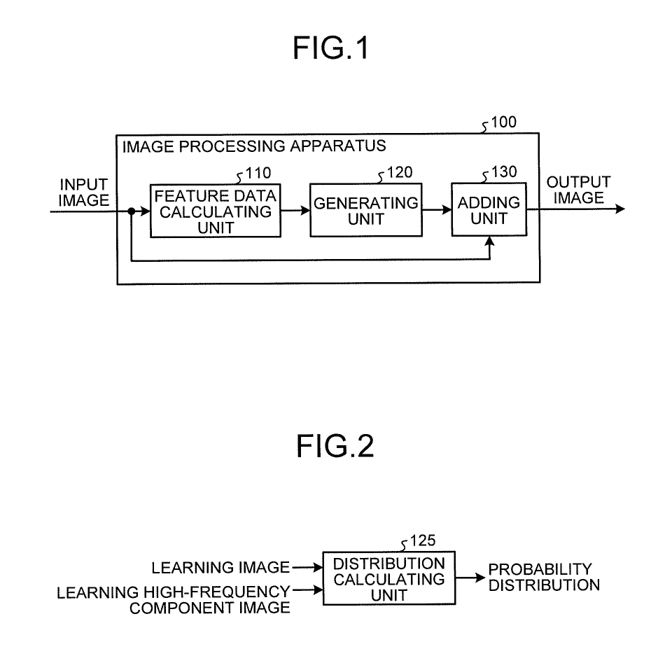

FIG. 1 is a block diagram of a configuration example of an image processing apparatus according to the first embodiment. As illustrated in FIG. 1, an image processing apparatus 100 includes a feature data calculating unit 110, a generating unit 120, and an adding unit 130. The image processing apparatus 100 is installed in, for example, a camera or a television receiver; and performs a variety of image processing with respect to an input image before outputting it. Meanwhile, the image quality of an input image may deteriorate due to reasons such as shooting, compression, enlargement, and reduction.

From an input image, the feature data calculating unit 110 calculates feature data that represents changes in the pixel values within a predetermined range. For example, the feature data calculating unit 110 makes use of a differential filter and calculates the gradient feature of the brightness of the input image. More specifically, using a differential filter in the horizontal direction or a differential filter in the vertical direction, the feature data calculating unit 110 obtains the gradient feature in the horizontal direction and the gradient feature in the vertical direction in each pixel. Herein, it is assumed that the filter is, for example, a 3×3 filter or a 5×5 filter. In the following explanation, the gradient feature in the horizontal direction is sometimes referred to as “Fx” and the gradient feature in the vertical direction is sometimes referred to as “Fy”.

Based on a probability distribution that represents the distribution of relative values of the feature data of a learning image containing a high-frequency component with respect to the feature data of a learning image, and based on the feature data calculated by the feature data calculating unit 110; the generating unit 120 obtains the weight of a predetermined image pattern, which represents a pattern of changes in the pixel values. Then, the generating unit 120 weights the predetermined image pattern with the obtained weight so as to generate a high-frequency component with respect to the input image.

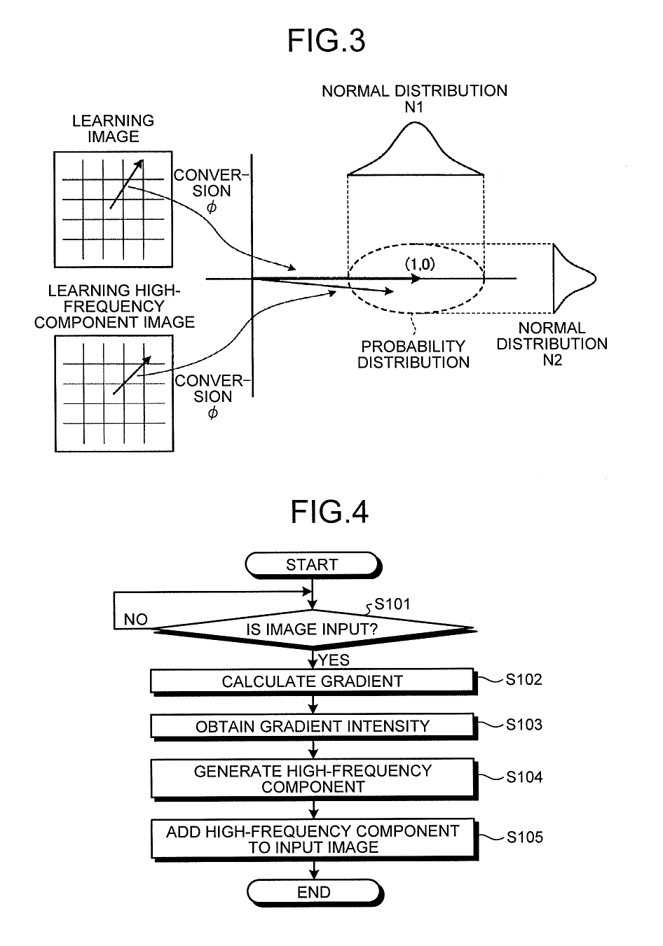

For example, based on a probability distribution that represents the distribution of relative angles and sizes of the gradient of a learning high-frequency component image with respect to the gradient of a learning image, and based on the gradient feature (Fx, Fy) that is calculated by the feature data calculating unit 110; the generating unit 120 obtains the gradient intensity of the high-frequency component. The following explanation is given about the probability distribution mentioned above. FIG. 2 is a diagram for explaining a distribution calculating unit according to the first embodiment. Herein, a distribution calculating unit 125 can either be disposed inside the image processing apparatus 100 or be disposed outside the image processing apparatus 100. That is, as long as the generating unit 120 is able to refer to the probability distribution output by the distribution calculating unit 125, either configuration is possible. FIG. 3 is a diagram for explaining the probability distribution according to the first embodiment.

As illustrated in FIG. 2 and FIG. 3, for example, the distribution calculating unit 125 calculates the gradient of a particular pixel in a learning image and the gradient of the corresponding pixel in a learning high-frequency component image. Meanwhile, in a similar fashion to an input image, there are times when a learning image has a deteriorated image quality. A learning image is obtained, for example, by reducing a high-resolution image and then enlarging the reduced image. The filter that is used in calculating the gradient of a learning image is identical to the filter used by the feature data calculating unit 110.

Then, in an area in which the x-axis of the probability distribution serves as the gradient direction in each pixel of a learning image and in which the y-axis of the probability distribution serves as the direction perpendicular to the gradient direction, the distribution calculating unit 125 converts the gradient of the learning image into a vector of (1, 0); and accordingly obtains a vector by means of relative conversion of the gradient of the learning high-frequency component image. In FIG. 3, “conversion φ” is illustrated to represent an identical conversion. Thus, the variability in the gradient of each pixel of a learning high-frequency component image is considered to be the probability distribution as illustrated by a dashed line in FIG. 3. Moreover, as illustrated in FIG. 3, the probability distribution is expressed with two-dimensional normal distributions, namely, “normal distribution N1” and “normal distribution N2”. Furthermore, the probability distribution is provided in advance.

Thus, during the calculation of the gradient intensity; from a random variable “α” obtained from the “normal distribution N1” having an average “μ1” and a standard deviation “σ1” and from a random variable “β” obtained from the “normal distribution N2” having an average “μ2” and a standard deviation “σ2”, the generating unit 120 obtains the gradient intensity of a high-frequency component according to Equation (1) given below.

fx=αFx+βFy,fy=αFy−βFx (1)

In Equation (1), “fx” represents the gradient intensity in the horizontal direction and “fy” represents the gradient intensity in the vertical direction.

Then, based on the gradient intensity (horizontal direction: fx, vertical direction: fy) of the high-frequency component and based on the local gradient pattern (horizontal direction: Gx, vertical direction: Gy), the generating unit 120 generates a high-frequency component with respect to the input image. Herein, “Gx” and “Gy” are base patterns having identical brightness change to the filter used by the distribution calculating unit 125 in calculating the gradient of the learning high-frequency component image. Thus, based on the gradient intensity and the local gradient pattern, the generating unit 120 generates a high-frequency component “T” with respect to the input image according to Equation (2) given below.

T=fx·Gx+fy·Gy (2)

The adding unit 130 adds the high-frequency component to the input image. For example, the adding unit 130 outputs an output image obtained by adding the high-frequency component, which is generated by the generating unit 120, to the input image. The output image has the same image size as the image size of the input image. Meanwhile, in the first embodiment, although the explanation is given for an exemplary case in which the gradient feature is calculated using a differential filter in the horizontal direction that is the x-axis direction and using a differential filter in the vertical direction that is the y-axis direction; it is also possible to make use of any other type of filter and any other feature other than the gradient that can be extracted using the filter.

Explained below with reference to FIG. 4 is a sequence of operations followed during the image processing according to the first embodiment. FIG. 4 is a flowchart for explaining a sequence of operations followed during the image processing according to the first embodiment.

For example, as illustrated in FIG. 4, when an input image is input to the image processing apparatus 100 (Yes at Step S101), the feature data calculating unit 110 makes use of a differential filter in the horizontal direction or a differential filter in the vertical direction and calculates the gradient feature in the horizontal direction and the gradient feature in the vertical direction in each pixel (Step S102). On the other hand, when no input image is input to the image processing apparatus 100 (No at Step S101), the feature data calculating unit 110 waits for the input of an input image.

Then, based on a probability distribution that represents the distribution of the vector indicating the relative sizes and angles of the gradient of a learning high-frequency component image with respect to the gradient of a learning image, and based on the feature data calculated by the feature data calculating unit 110; the generating unit 120 obtains the gradient intensity of the high-frequency component (Step S103). Subsequently, based on the gradient intensity of the high-frequency component and based on the local gradient pattern, the generating unit 120 generates a high-frequency component with respect to the input image (Step S104). Moreover, the adding unit 130 outputs an output image obtained by adding the high-frequency component, which is generated by the generating unit 120, to the input image (Step S105).

According to the first embodiment, from the feature data of each pixel of an input image that has a deteriorated image quality and from a probability distribution that represents the distribution of a relative vector of the gradient of a learning image containing a high-frequency component with respect to the gradient of a learning image that has a deteriorated image quality, the high-frequency component of an input image is generated and is then added to the input image. As a result, it becomes possible to generate an image having sharpness as well as naturalness.

### Second Embodiment

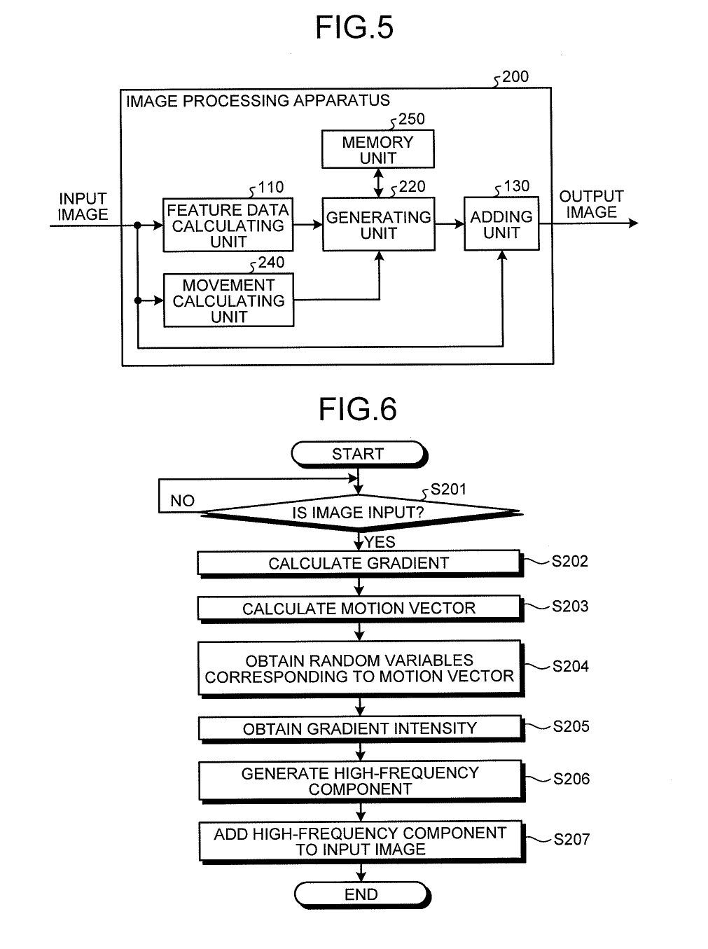

FIG. 5 is a block diagram of a configuration example of an image processing apparatus according to a second embodiment. In the second embodiment, the functional components that perform identical operations to the operations performed in the first embodiment are referred to by the same reference numerals, and the explanation of the identical operations may not be repeated. Moreover, in the second embodiment, the explanation is given for an exemplary case in which image processing is performed with respect to two or more frames (input images).

For example, as illustrated in FIG. 5, an image processing apparatus 200 includes the feature data calculating unit 110, a generating unit 220, the adding unit 130, a movement calculating unit 240, and a memory unit 250. Meanwhile, in an identical manner to the first embodiment, the image processing apparatus 200 is installed in a camera or a television receiver; and performs a variety of image processing with respect to an input image before outputting it. Moreover, the image quality of an input image may deteriorate due to reasons such as shooting, compression, enlargement, and reduction.

The movement calculating unit 240 calculates the movement of each pixel based on a first input image and based on a second input image that has been input previous to the input of the first input image. For example, the movement calculating unit 240 calculates a motion vector that represents the amount of change in the movement from the pixels of the target input image for image processing to the pixels of the input image that has been previously processed. Herein, the movement calculating unit 240 can calculate the motion vector at the pixel accuracy level as described above or at the sub-pixel accuracy level smaller than a single pixel.

The memory unit 250 is used to store therein random variables each obtained from the probability distribution representing the distribution of relative values of the feature data of a learning image containing a high-frequency component with respect to the feature data of a learning image, and each corresponding to the movement of a pixel. For example, the memory unit 250 is used to store therein only a predetermined number of random variables that are obtained from the probability distribution calculated by the distribution calculating unit 125. The number of random variables stored in the memory unit 250 is not more than the number of pixels of the input image. Moreover, when the image processing is performed with respect to the input image, the memory unit 250 serves as a memory area corresponding to the coordinates represented by the motion vector so that it becomes possible to know the random variables used during the image processing performed with respect to the previous input image.

The generating unit 220 obtains the random variable corresponding to the calculated movement, and accordingly obtains the weight of a predetermined image pattern that represents the pattern of changes in the pixel values. Then, the generating unit 220 weights the predetermined image pattern with the obtained weight and generates a high-frequency component with respect to the input image.

For example, of the memory unit 250, from the memory area corresponding to the coordinate positions of the previously-processed input image that is represented by the motion vector calculated by the movement calculating unit 240; the generating unit 220 obtains a random variable “a” and a random variable “β”. As an example, when the motion vector at coordinates (i, j) of an input image represents coordinates (k, l) of the previously-processed input image and when the memory unit 250 has a memory area “M×N”; the generating unit 220 obtains the random variable of the coordinates (i, j) from the position (k mod M, l mod N) of the memory unit 250. Herein, “k mod M” represents the remainder when “k” is divided by “M”; and “l mod N” represents the remainder when “l” is divided by “N”.

Then, based on the random variable “a” and the random variable “β” as well as based on the gradient feature (Fx, Fy) calculated by the feature data calculating unit 110, the generating unit 220 obtains the gradient intensity of the high-frequency component according to Equation (1). Subsequently, based on the gradient intensity (horizontal direction: fx, vertical direction: fy) of the high-frequency component and based on the local gradient pattern (horizontal direction: Gx, vertical direction: Gy), the generating unit 220 generates the high-frequency component “T” with respect to the input image according to Equation (2).

Explained below with reference to FIG. 6 is a sequence of operations followed during the image processing according to the second embodiment. FIG. 6 is a flowchart for explaining a sequence of operations followed during the image processing according to the second embodiment.

For example, as illustrated in FIG. 6, when an input image is input to the image processing apparatus 200 (Yes at Step S201), the feature data calculating unit 110 makes use of a differential filter in the horizontal direction or a differential filter in the vertical direction and calculates the gradient feature in the horizontal direction and the gradient feature in the vertical direction in each pixel (Step S202). On the other hand, when no input image is input to the image processing apparatus 200 (No at Step S201), the feature data calculating unit 110 waits for the input of an input image.

Then, the movement calculating unit 240 calculates a motion vector that represents the amount of change in the movement from the pixels of the target input image for image processing to the pixels of the input image that has been previously processed (Step S203). Subsequently, of the memory unit 250, from the memory area corresponding to the coordinate positions of the previously-processed input image represented by the motion vector calculated by the movement calculating unit 240; the generating unit 220 obtains random variables (Step S204).

Based on the obtained random variables and based on the gradient feature calculated by the feature data calculating unit 110, the generating unit 220 obtains the gradient intensity of the high-frequency component (Step S205). Then, based on the gradient intensity of the high-frequency component and based on the local gradient pattern, the generating unit 220 generates a high-frequency component with respect to the input image (Step S206). Subsequently, the adding unit 130 outputs an output image obtained by adding the high-frequency component, which is generated by the generating unit 220, to the input image (Step S207).

According to the second embodiment, the memory unit 250 is used that has a memory area corresponding to the coordinates represented by a motion vector of the movement from the target input image for image processing to the previously-processed input image. Hence, it becomes possible to understand the random variables used during the image processing performed with respect to the previous input image. That enables achieving prevention of the flickering of a moving image. When the random variables are obtained independently in each frame, there is a possibility that the values used in the operations related to image processing are different for each frame. Because of that, the image processing result differs in each frame, which may lead to the flickering of a moving image. In that regard, in the second embodiment, the flickering of a moving image is prevented by making use of the memory unit 250.

### Third Embodiment

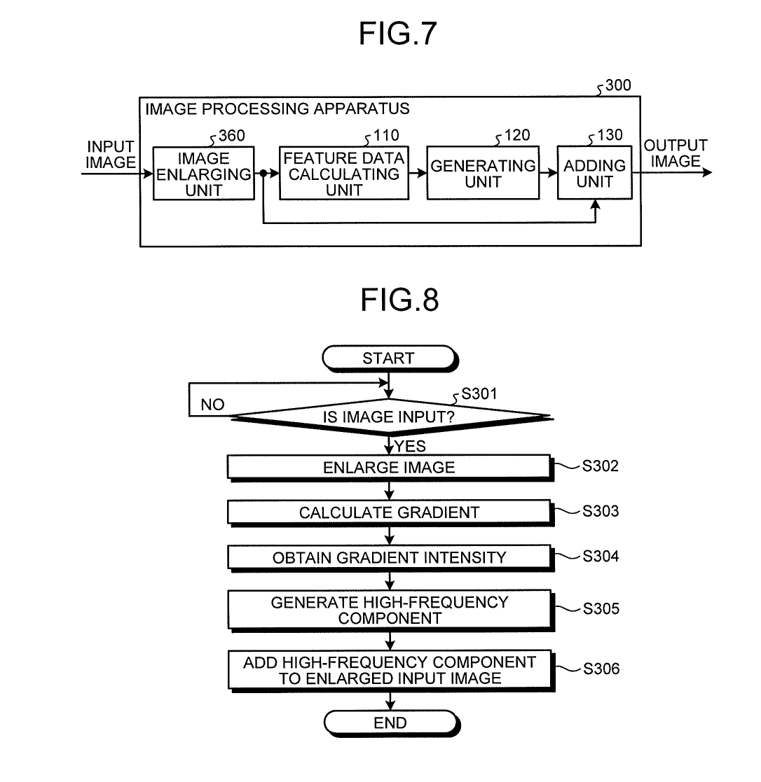

FIG. 7 is a block diagram of a configuration example of an image processing apparatus according to a third embodiment. In the third embodiment, the functional components that perform identical operations to the operations performed in the first embodiment are referred to by the same reference numerals, and the explanation of the identical operations may not be repeated.

For example, as illustrated in FIG. 7, an image processing apparatus 300 includes the feature data calculating unit 110, the generating unit 120, the adding unit 130, and an image enlarging unit 360. Meanwhile, in an identical manner to the first embodiment, the image processing apparatus 300 is installed in a camera or a television receiver; and performs a variety of image processing with respect to an input image before outputting it. Moreover, the image quality of an input image may deteriorate due to reasons such as shooting, compression, enlargement, and reduction.

The image enlarging unit 360 enlarges an input image to generate an enlarged input image. For example, the image enlarging unit 360 enlarges an input image using any image enlarging method such as the nearest-neighbor interpolation method, the linear interpolation method, or the cubic convolution method; and generates an enlarged input image. Then, that enlarged input image is input to the feature data calculating unit 110 and the adding unit 130. As far as the image enlarging methods are concerned, many methods have been proposed to enlarge images by means of interpolation of pixel values as mentioned above. However, it is desirable to implement a method that results in as less blurring as possible in the obtained images.

With respect to the enlarged input image that is enlarged by the image enlarging unit 360; the feature data calculating unit 110, the generating unit 120, and the adding unit 130 perform image processing in an identical manner to the first embodiment. Hence, the detailed explanation thereof is not repeated. Herein, an output image is obtained when the abovementioned image processing is performed on the enlarged input image that is larger in size than the input image.

Explained below with reference to FIG. 8 is a sequence of operations followed during the image processing according to the third embodiment. FIG. 8 is a flowchart for explaining a sequence of operations followed during the image processing according to the third embodiment.

For example, as illustrated in FIG. 8, when an input image is input to the image processing apparatus 300 (Yes at Step S301), the image enlarging unit 360 enlarges the input image using an arbitrary image enlarging method and generates an enlarged input image (Step S302). On the other hand, when no input image is input to the image processing apparatus 300 (No at Step S301), the image enlarging unit 360 waits for the input of an input image.

Then, the feature data calculating unit 110 makes use of a differential filter in the horizontal direction or a differential filter in the vertical direction and calculates the gradient feature in the horizontal direction and the gradient feature in the vertical direction in each pixel of the enlarged input image generated by the image enlarging unit 360 (Step S303). Subsequently, based on a probability distribution that represents the distribution of the vector indicating the relative sizes and angles of the gradient of a learning high-frequency component image with respect to the gradient of a learning image, and based on the feature data calculated by the feature data calculating unit 110; the generating unit 120 obtains the gradient intensity of the high-frequency component (Step S304).

Then, based on the gradient intensity of the high-frequency component and based on the local gradient pattern, the generating unit 120 generates a high-frequency component with respect to the enlarged input image (Step S305). Moreover, the adding unit 130 outputs an output image obtained by adding the high-frequency component, which is generated by the generating unit 120, to the enlarged input image (Step S306).

According to the third embodiment, the high-frequency component of an enlarged input image is generated based on the feature data of each pixel of the enlarged input image that has a deteriorated image quality as a result of enlarging the input image and based on a probability distribution representing the distribution of a relative vector of a learning image containing the high-frequency component with respect to a learning image having a deteriorated image quality. Then, the high-frequency component is added to the enlarged input image. As a result, it becomes possible to generate an image having sharpness as well as naturalness.

### Fourth Embodiment

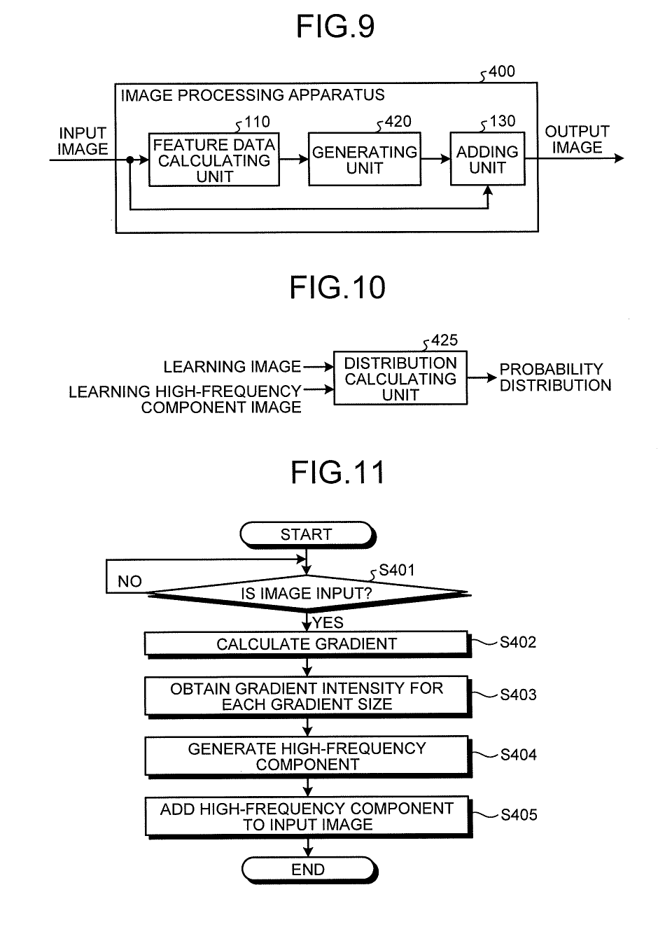

FIG. 9 is a block diagram of a configuration example of an image processing apparatus according to a fourth embodiment. In the fourth embodiment, the functional components that perform identical operations to the operations performed in the first embodiment are referred to by the same reference numerals, and the explanation of the identical operations may not be repeated.

For example, as illustrated in FIG. 9, an image processing apparatus 400 includes the feature data calculating unit 110, a generating unit 420, and the adding unit 130. Meanwhile, in an identical manner to the first embodiment, the image processing apparatus 400 is installed in a camera or a television receiver; and performs a variety of image processing with respect to an input image before outputting it. Moreover, the image quality of an input image may deteriorate due to reasons such as shooting, compression, enlargement, and reduction.

Based on a probability distribution corresponding to the size of the calculated feature data from among a plurality of probability distributions obtained for the different sizes of feature data of the learning image as well as based on the calculated feature data, the generating unit 420 obtains the weight of a predetermined image pattern that represents a pattern of changes in the pixel values. Then, the generating unit 420 weights the predetermined image pattern with the obtained weight so as to generate a high-frequency component with respect to the input image.

For example, based on the probability distribution that is obtained for each gradient size of the learning image and that represents the distribution of relative angles of the gradient of the learning high-frequency component image with respect to the gradient of the learning image, as well as based on the gradient feature (Fx, Fy) calculated by the feature data calculating unit 110; the generating unit 420 obtains the gradient intensity of the high-frequency component. The following explanation is given about the probability distributions mentioned above. FIG. 10 is a diagram for explaining a distribution calculating unit according to the fourth embodiment.

For example, as illustrated in FIG. 10, a distribution calculating unit 425 calculates the gradient of a particular pixel in a learning image and the gradient of the corresponding pixel in a learning high-frequency component image. Meanwhile, in a similar fashion to an input image, there are times when a learning image has a deteriorated image quality. The filter that is used in calculating the gradient of a learning image is identical to the filter used by the feature data calculating unit 110.

Then, in an area in which the x-axis of the probability distribution serves as the gradient direction in each pixel of a learning image and in which the y-axis of the probability distribution serves as the direction perpendicular to the gradient direction, the distribution calculating unit 425 rotates the gradient direction of the learning image to the x-axis direction; and, when the gradient of the learning high-frequency component image is also rotated accordingly, the distribution calculating unit 425 considers the variability in the gradient of the learning high-frequency component image as the probability distribution. Herein, the probability distribution is obtained for each gradient size of the learning image. Moreover, each probability distribution is expressed with two-dimensional normal distributions. Furthermore, the probability distributions are provided in advance.

Thus, during the calculation of the gradient intensity, from the random variable “α” obtained from the normal distribution having the average “μ1” and the standard deviation “σ1” and from the random variable “β” obtained from the normal distribution having the average “μ2” and the standard deviation “σ2”; the generating unit 420 obtains the gradient intensity of the high-frequency component according to Equation (3) given below.

$$fx = \frac{α Fx + β Fy}{\sqrt{{Fx}^{2} + {Fy}^{2}}} , fy = \frac{α Fy - β Fx}{\sqrt{{Fx}^{2} + {Fy}^{2}}} \qquad ( 3 )$$

In Equation (3), “fx” represents the gradient intensity in the horizontal direction and “fy” represents the gradient intensity in the vertical direction.

Then, based on the gradient intensity (horizontal direction: fx, vertical direction: fy) of the high-frequency component and based on the local gradient pattern (horizontal direction: Gx, vertical direction: Gy), the generating unit 420 generates a high-frequency component with respect to the input image. Herein, “Gx” and “Gy” are base patterns having identical brightness change as the filter used by the distribution calculating unit 425 in calculating the gradient of the learning high-frequency component image. Thus, based on the gradient intensity and the local gradient pattern, the generating unit 120 generates the high-frequency component “T” with respect to the input image according to Equation (2).

Explained below with reference to FIG. 11 is a sequence of operations followed during the image processing according to the fourth embodiment. FIG. 11 is a flowchart for explaining a sequence of operations followed during the image processing according to the fourth embodiment.

For example, as illustrated in FIG. 11, when an input image is input to the image processing apparatus 400 (Yes at Step S401), the feature data calculating unit 110 makes use of a differential filter in the horizontal direction or a differential filter in the vertical direction and calculates the gradient feature in the horizontal direction and the gradient feature in the vertical direction in each pixel (Step S402). On the other hand, when no input image is input to the image processing apparatus 400 (No at Step S401), the feature data calculating unit 110 waits for the input of an input image.

Then, based on the probability distribution that is obtained for each gradient size of the learning image and that represents the distribution of relative angles of the gradient of the learning high-frequency component image with respect to the gradient of the learning image, as well as based on the gradient feature calculated by the feature data calculating unit 110; the generating unit 420 obtains the gradient intensity of the high-frequency component (Step S403). Subsequently, based on the gradient intensity of the high-frequency component and based on the local gradient pattern, the generating unit 420 generates a high-frequency component with respect to the input image (Step S404). Moreover, the adding unit 130 outputs an output image obtained by adding the high-frequency component, which is generated by the generating unit 420, to the input image (Step S405).

According to the fourth embodiment, from the feature data of each pixel of an input image that has a deteriorated image quality and from the probability distribution that is obtained for each gradient size of the learning image having a deteriorated image quality and that represents the distribution of the gradient of the learning high-frequency component image with respect to the gradient of the learning image, the high-frequency component of an input image is generated and is then added to the input image. As a result, it becomes possible to generate an image having sharpness as well as naturalness.

### Fifth Embodiment

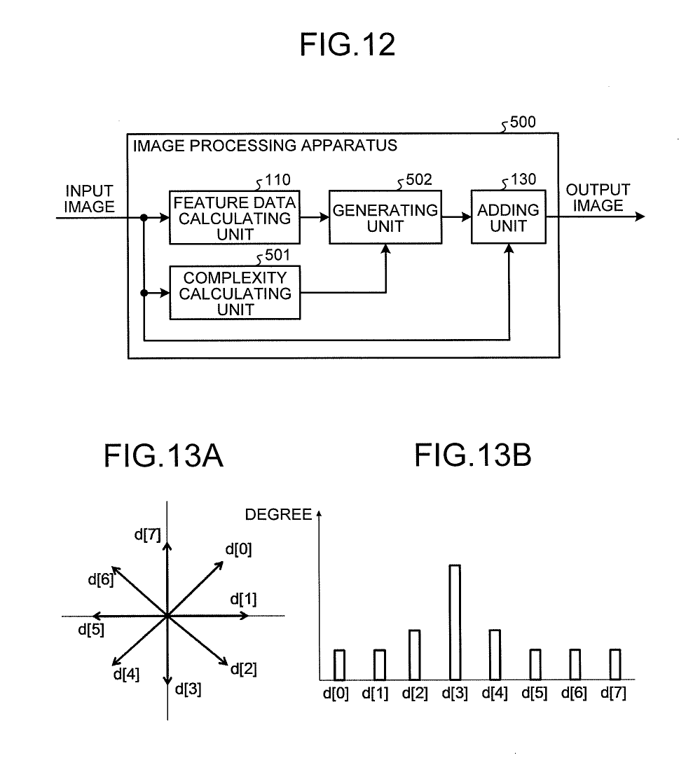

FIG. 12 is a block diagram of a configuration example of an image processing apparatus according to a fifth embodiment. In the fifth embodiment, the functional components that perform identical operations to the operations performed in the first embodiment are referred to by the same reference numerals, and the explanation of the identical operations may not be repeated.

As illustrated in FIG. 12, an image processing apparatus 500 includes the feature data calculating unit 110, a generating unit 502, a complexity calculating unit 501, and the adding unit 130. Meanwhile, in an identical manner to the first embodiment, the image processing apparatus 500 is installed in a camera or a television receiver; and performs a variety of image processing with respect to an input image before outputting it. Moreover, the image quality of an input image may deteriorate due to reasons such as shooting, compression, enlargement, and reduction.

The complexity calculating unit 501 calculates, from an input image, the feature data representing the complexity of changes in the pixel values within a predetermined range. For example, the complexity calculating unit 501 calculates a complexity z of changes in the pixel values by referring to the bias of a histogram in the gradient direction of each pixel within a predetermined range of the input image. The gradient direction of each pixel is expressed, for example, by one of directions d[0] to d[7] illustrated in FIG. 13A. That is followed by obtaining histograms in the gradient directions of the pixels included within the predetermined range of the input image (for example, FIG. 13B). Meanwhile, in FIG. 13A, although the gradient directions are expressed as any of the eight directions, that is not the only possible case.

As the bias of a histogram, it is possible to use the maximum value in that histogram or the dispersion of that histogram. In the case of using the maximum value of a histogram, greater the maximum value, greater is the bias; and smaller the maximum value, smaller is the bias. In the case of using the dispersion of a histogram, smaller the dispersion, greater is the bias; and greater the dispersion, smaller is the bias. When the bias is small, the complexity z increases. In contrast, when the bias is large, the complexity z decreases. The complexity z takes a value in the range of 0 to 1. In this way, since the complexity is calculated with the use of the bias of histograms, the unit of calculating the bias is broader than the unit of calculating the feature data. For example, the unit of calculating the bias is in the range of 36 pixels×36 pixels.

The generating unit 502 obtains a predetermined image pattern that represents a pattern of changes in the pixel values. Then, the generating unit 502 weights the predetermined image pattern with the obtained weight so as to generate a high-frequency component with respect to the input image. In that regard, the generating unit 502 is identical to the generating unit 120. However, the generating unit 120 obtains the gradient intensity (fx, fy) based on the feature data (Fx, Fy), which is calculated by the feature data calculating unit 110, and based on the probability distribution (α, β), which is obtained by the distribution calculating unit 125, according to Equation (1). In comparison, the generating unit 502 additionally makes use of the complexity z calculated by the complexity calculating unit 501.

For example, if the complexity z is large, the generating unit 502 makes use of the probability distribution (α, β) to calculate the gradient intensity (fx, fy); and if the complexity z is small, the generating unit 502 makes use of a fixed value (p, q) to calculate the gradient intensity (fx, fy). More particularly, the generating unit 502 compares the complexity z with a predetermined threshold value. If the complexity z is equal to or greater than the predetermined threshold value, then the generating unit 502 makes use of the probability distribution (α, β) to calculate the gradient intensity (fx, fy) according to Equation (1). On the other hand, if the complexity z is smaller than the predetermined threshold value, then the generating unit 502 makes use of a fixed value (p, q) to calculate the gradient intensity (fx, fy) according to Equation (4) given below.

fx=pFx+qFy,fy=pFy−qFx (4)

Meanwhile, depending on the value of the complexity z, the generating unit 502 can continuously control the proportion of the fixed value (p, q) to the probability distribution (α, β) for the calculation of the gradient intensity (fx, fy). More particularly, for example, according to Equation (5) given below, the fixed value (p, q) is blended with the probability distribution (α, β) at a blending rate that depends on the complexity z.

fx=(zα+(1−z)p)Fx+(zβ+(1−z)q)Fy,

fy=(zα+(1−z)p)Fy−(zβ+(1−z)q)Fx (5)

The fixed value (p, q) can be any arbitrary value. However, with the aim of preventing variability due to the probability distribution, it is desirable to use the average value of the probability distribution as the fixed value (p, q). For example, in the case of using the probability distribution expressed with two-dimensional normal distributions as used in the distribution calculating unit 125; the fixed value p can be set to be the average “μ1” of the normal distribution N1 and the fixed value q can be set to be the average “μ2” of the normal distribution N2.

The gradient intensity (fx, fy) obtained in the abovementioned manner is used as the weight of the predetermined image pattern to generate the high-frequency component with respect to the input image. The method of generating the high-frequency component is identical to that implemented by the generating unit 120.

According to the fifth embodiment, in a complex texture area without any orientation, the use of the probability distribution makes it possible to generate a high-frequency component having natural variability. In contrast, in a regular texture area such as a grain having an orientation, it becomes possible to generate a sharp high-frequency component without any variability.

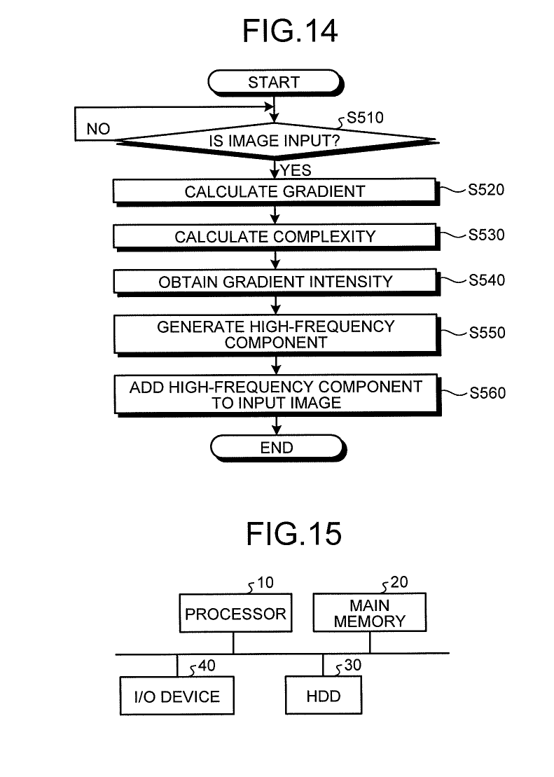

Explained below with reference to FIG. 14 is a sequence of operations followed during the image processing according to the fifth embodiment. For example, as illustrated in FIG. 14, when an input image is input to the image processing apparatus 500 (Yes at Step S510); the complexity calculating unit 501 calculates, from the input image, the feature data that represents the complexity of changes in pixel values within a predetermined range (Step S530).

Moreover, when an input image is input to the image processing apparatus 500 (Yes at Step S510), the feature data calculating unit 110 makes use of a differential filter in the horizontal direction or a differential filter in the vertical direction and calculates the gradient feature in the horizontal direction and the gradient feature in the vertical direction in each pixel (Step S520). Then, based on a probability distribution that represents the distribution of the vector indicating the relative sizes and angles of the gradient of a learning high-frequency component image with respect to the gradient of a learning image, based on the complexity calculated by the complexity calculating unit 501, and based on the feature data calculated by the feature data calculating unit 110; the generating unit 120 obtains the gradient intensity of the high-frequency component (Step S540).

Subsequently, based on the gradient intensity of the high-frequency component and based on the local gradient pattern, the generating unit 120 generates a high-frequency component with respect to the input image (Step S550). Moreover, the adding unit 130 outputs an output image obtained by adding the high-frequency component, which is generated by the generating unit 120, to the input image (Step S560).

Meanwhile, the functions of the image processing apparatus described above in each embodiment can be implemented by executing an image processing program, which is written in advance, in a computer such as a personal computer or a workstation. For example, an image processing program that implements the functions of the image processing apparatus is stored in a main memory 20 of a computer illustrated in FIG. 15. Then, a processor 10 executes that image processing program. The output images processed by the image processing apparatus can be output, for example, to a display connected via an input-output device 40 or to a device connected via the Internet. This image processing program can be distributed via a network such as the Internet. Alternatively, the image processing program can be stored in a computer-readable recording medium such as a hard disk (a hard disk drive 30), a flexible disk (FD), a compact disk read only memory (CD-ROM), a magnetooptic disk (MO), or a digital versatile disk (DVD). Then, a computer can read the image processing program from the recording medium and execute it.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image processing apparatus comprising:
a feature data calculator configured to calculate feature data representing changes in pixel values within a first range of an input image;
a generating unit configured
to obtain a weight of a predetermined image pattern on the basis of probability distribution and the feature data, the weight representing a pattern of changes in the pixel values, the probability distribution representing a distribution of relative values of feature data of a learning image containing a high-frequency component with respect to feature data of a learning image, and
to weight the predetermined image pattern with the weight so as to generate a high-frequency component with respect to the input image; and
an adding unit configured to add the high-frequency component to the input image.

2. The apparatus according to claim 1, further comprising:
a movement calculator configured to calculate movement of each pixel on the basis of a first input image and on the basis of a second input image that has been input previous to the first input image; and
a storing unit configured to store therein random variables each corresponding to the movement of one of the pixels and each obtained from the probability distribution, wherein
the generating unit obtains, from the storing unit, the random variables corresponding to the calculated movements, and obtains the weight of the predetermined image pattern on the basis of the random variables and on the basis of the feature data.

3. The apparatus according to claim 1, further comprising an image enlarging unit configured to enlarge the input image so as to generate an enlarged input image, wherein
the feature data calculator calculates the feature data within a predetermined range of the enlarged input image,
the generating unit obtains the weight of the predetermined image pattern on the basis of the probability distribution and on the basis of the calculated feature data, and weights the predetermined image pattern with the obtained weight so as to generate a high-frequency component with respect to the enlarged input image, and
the adding unit adds the high-frequency component to the enlarged input image.

4. The apparatus according to claim 1, wherein the generating unit obtains the weight of the predetermined image pattern on the basis of the probability distribution corresponding to the size of the calculated feature data, from among a plurality of the probability distributions obtained with respect to all sizes of the feature data of the learning image, and on the basis of the calculated feature data.

5. A computer program product comprising a computer-readable medium containing an image processing program, the program causing a computer to execute:
calculating feature data representing changes in pixel values within a first range of an input image;
obtaining a weight of a predetermined image pattern on the basis of a probability distribution and the feature data, the weight representing a pattern of changes in the pixel values, the probability distribution representing a distribution of relative values of feature data of a learning image containing a high-frequency component with respect to feature data of a learning image;
generating a high-frequency component with respect to the input image by weighting the predetermined image pattern with the weight; and
adding the high-frequency component to the input image.

6. An image processing method implemented in an image processing apparatus, the image processing method comprising:
calculating, by a feature data calculator, feature data representing changes in pixel values within a first range of an input image;
obtaining, by a generating unit, a weight of a predetermined image pattern on the basis of a probability distribution and the feature data, the weight representing a pattern of changes in the pixel values, the probability distribution representing a distribution of relative values of feature data of a learning image containing a high-frequency component with respect to feature data of a learning image;
generating, by the generating unit, a high-frequency component with respect to the input image by weighting the predetermined image pattern with the weight; and
adding, by an adding unit, the high-frequency component to the input image.

7. The apparatus according to claim 1, wherein
the feature data calculator further calculates complexity of changes in pixel values within a second range of the input image;
the generating unit obtains the weight on the basis of the probability distribution, the feature data and the complexity calculated by the feature data calculator.

8. The apparatus according to claim 7, wherein the generating unit calculates the weight using a third value, the third value is obtained by combining a first value obtained from the probability distribution and a predetermined second value at a proportion depending on the complexity.

9. The apparatus according to claim 7, wherein, when the complexity is equal to or greater than a predetermined threshold value, the generating unit calculates the weight using a first value obtained from the probability distribution and using the feature data calculated by the feature data calculator, and when the complexity is smaller than the predetermined threshold value, the generating unit calculates the weight using a predetermined second value and using the feature data calculated by the feature data calculator.

10. The apparatus according to claim 8, wherein the second value is the average value of the probability distribution.

11. The apparatus according to claim 9, wherein the second value is the average value of the probability distribution.

12. The apparatus according to claim 7, further comprising:
a movement calculator configured to calculate movement of each pixel on the basis of a first input image and on the basis of a second input image that has been input previous to the first input image; and
a storing unit configured to store therein random variables each corresponding to the movement of one of the pixels and each obtained from the probability distribution, wherein
the generating unit obtains, from the storing unit, the random variables corresponding to the calculated movements, and obtains the weight of the predetermined image pattern on the basis of the random variables and on the basis of the calculated feature data.

13. The apparatus according to claim 7, further comprising an image enlarging unit that enlarges the input image so as to generate an enlarged input image, wherein
the feature data calculator calculates the feature data within a predetermined range of the enlarged input image,
the generating unit obtains the weight of the predetermined image pattern on the basis of the probability distribution and on the basis of the calculated feature data, and weights the predetermined image pattern with the obtained weight so as to generate a high-frequency component with respect to the enlarged input image, and
the adding unit adds the high-frequency component to the enlarged input image.

14. The apparatus according to claim 1, wherein the generating unit obtains the weight of the predetermined image pattern on the basis of the probability distribution corresponding to the size of the calculated feature data, from among a plurality of the probability distributions obtained with respect to all sizes of the feature data of the learning image, and on the basis of the calculated feature data.

15. The computer program product according to claim 5, wherein
the calculating further includes
calculating complexity of changes in pixel values within a second range of the input image; and
the generating obtains the weight on the basis of the probability distribution, the feature data and the complexity.

16. The method according to claim 6, wherein
the calculating further includes
calculating complexity of changes in pixel values within a second range of the input image; and
the generating obtains the weight on the basis of the probability distribution, the feature data and the complexity.
